(19) United States
(12) Patent Application Publication
(10) Pub. No.: US 2026/0268887 A1
(43) Pub. Date: Sep. 10, 2026

(54) SYSTEM AND/OR METHOD FOR SEMANTIC AIRCRAFT COMMUNICATIONS

(71) Applicant: Merlin Labs, Inc., Boston, MA (US)

(72) Inventors: Tim Burns, Boston, MA (US); Moslem Kazemi, Boston, MA (US)

(73) Assignee: Merlin Labs, Inc., Boston, MA (US)

(21) Appl. No.: 19/556,862

(22) Filed: Mar. 4, 2026

Related U.S. Application Data
(60) Provisional application No. 63/766,831, filed on Mar. 4, 2025.

(51) Int. Cl. G10L 13/033; G08G 5/24; G10L 15/02; G10L 15/18; G10L 15/187; G10L 15/22

(52) U.S. Cl. CPC G10L 13/033; G08G 5/24; G10L 15/02; G10L 15/1815; G10L 15/1822; G10L 15/187; G10L 15/22; G10L 2015/223

(57) ABSTRACT

A method can include: receiving an audio utterance from air traffic control, characterizing speech attributes based on the audio utterance, and generating a synthetic speech response based on the speech attributes. The method can optionally include: converting the audio utterance into a predetermined format, determining a response, and/or any other suitable element(s). However, the method can include any other suitable elements. The method functions to automatically interpret flight commands from a stream of air traffic control (ATC) radio communications and respond to ATC with a selected accent and/or set of synthetic speech attributes based on the speaker attributes.

### CROSS REFERENCE TO RELATED APPLICATIONS

This application claims the benefit of U.S. Provisional Application No. 63/766,831, filed 04-MAR-2025, which is incorporated herein in its entirety by this reference.

### TECHNICAL FIELD

This invention relates generally to the aviation field, and more specifically to a new and useful semantic aircraft communication system and/or method in the aviation field.

### BACKGROUD

A majority of Air Traffic Control (ATC) radio communications are conducted in English globally. However, air traffic controllers and pilots possess diverse accents, which can pose semantic comprehension challenges for ATC radio communications, including those leveraging synthetic vocalizations. Pilots and air traffic controllers often come from diverse linguistic backgrounds, which can lead to misunderstandings, delays, and, in some cases, present safety hazards.

While International Civil Aviation Organization (ICAO) standards help reduce the risk of misunderstandings, accents—whether regional or non-native—can still lead to miscommunication and comprehension challenges, particularly in noisy environments or under high-stress conditions. In such scenarios, semantic comprehension may typically improve for speech in a familiar or native accent.

Therefore, there is a need for a semantic aircraft communication system to respond to air traffic controllers with synthetically generated speech in accents which are similar to the accent of the air traffic controller.

### BRIEF DESCRIPTION OF THE FIGURES

FIG. 1 is a schematic representation of a variant of the system.

FIG. 2 is a flowchart diagrammatic representation of a variant of the method.

FIG. 3 is a schematic representation of a variant of the system.

FIG. 4 is a schematic representation of a variant of the system.

FIG. 5 is a flowchart diagrammatic representation of a variant of the method.

FIG. 6 is a schematic representation of a variant of the system.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

The method S200 can include: receiving an audio utterance from air traffic control S210, characterizing speech attributes based on the audio utterance S220, and generating a synthetic speech response based on the speech attributes S230. The method can optionally include: converting the audio utterance into a predetermined format S215, determining a response S225, and/or any other suitable element(s). However, the method can include any other suitable elements. The method functions to automatically interpret flight commands from a stream of air traffic control (ATC) radio communications and respond to ATC with a selected accent and/or set of synthetic speech attributes based on the speaker attributes.

In variants, the system and/or method can include or operate in conjunction with any of the system and/or method elements as described in: U.S. Application Serial No. 18/423,149, filed 25-JAN-2024, U.S. Application Serial No. 18/423,149, filed 25-JAN-2024, U.S. Application Serial No. 17/719,835, filed 13-APR-2022, and/or U.S. Application Serial No. 18/952,583, filed 19-NOV-2024, each of which is incorporated herein in its entirety by this reference.

The system and/or method is preferably implemented in conjunction with and/or executed by an aircraft, such as a rotorcraft (e.g., helicopter, multi-copter), fixed-wing aircraft (e.g., airplane), Short Takeoff and Landing (STOL) aircraft, lighter-than-air aircraft, multi-copter, and/or any other suitable aircraft. The method can be implemented with an autonomous aircraft, unmanned aircraft (UAV), manned aircraft (e.g., with a pilot, with an unskilled operator executing primary aircraft control), semi-autonomous aircraft, single pilot aircraft, multi-pilot aircraft, and/or any other suitable aircraft. The aircraft is preferably an autonomous aircraft configured to execute flight commands according to a mission plan using a flight processor without user (e.g., pilot) intervention. Additionally or alternatively, the method can be implemented on a semi-autonomous vehicle (e.g., a human-in-the-loop aircraft with autonomous functionality and/or autonomous co-pilot) and/or human-operated vehicle as a flight aid.

The system and/or method can be implemented in conjunction with a fly-by-wire (FBW) aircraft, manually/mechanically controllable aircraft (e.g., with a mechanical flight control system and/or hydraulic flight control system), and/or any other suitable aircraft or vehicle system(s).

In variants, the system, processing components, method, and/or other elements of the system can be implemented in conjunction with a portable device (a.k.a., a “bring-aboard device”), as a pilot recommendation device, and/or as an after-market add-on (e.g., prior to an individual flight; after-market integration, etc.). For example, the system may be separately certified from the aircraft and/or critical infrastructure installed onboard the aircraft (e.g., separately certified portable device; not certified with a built-in Multi-Function Display [MFD]).

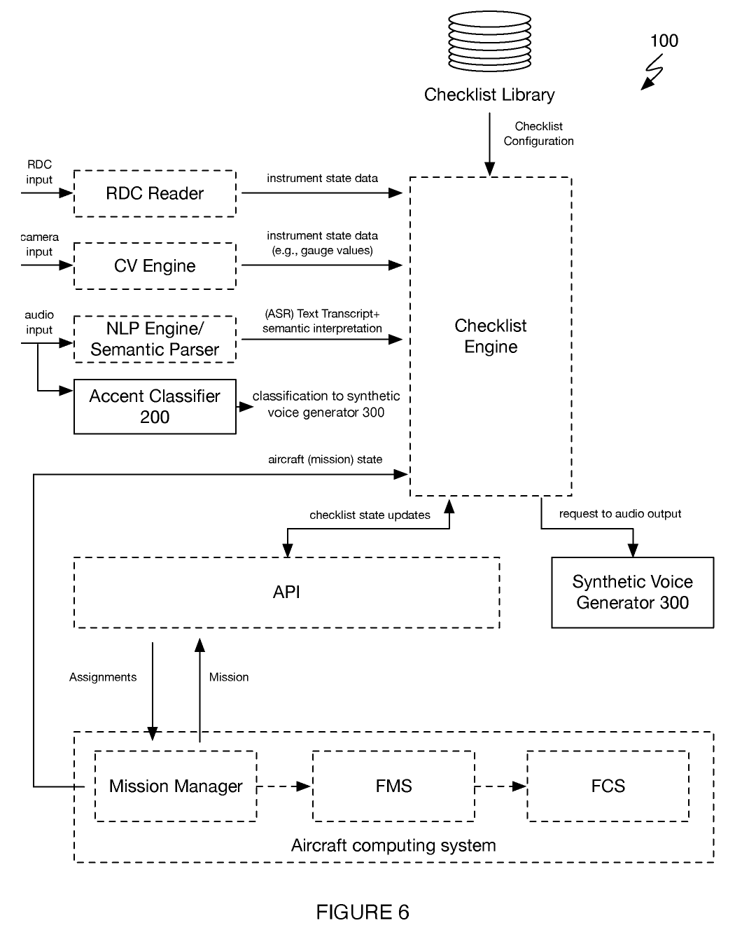

In variants, the system and/or method can be implemented within the low Design Assurance Level (DAL) and/or high DAL portions of the aircraft computing system(s) and/or aircraft computing architecture as described in U.S. Application 17/891,845, filed 19-AUG-2022, titled “ADVANCED FLIGHT PROCESSING SYSTEM AND/OR METHOD”, which is incorporated herein in its entirety by this reference. For example, attention monitoring, verification checks, and/or aircraft configuration state management, and/or alert level escalation(s) may be implemented at a high DAL portion of the aircraft computing system, with advanced functionalities (e.g., CV vision tracking; natural language processing [NLP] and/or communication parsing; co-pilot checklist tasks/verifications, an example of which is shown in FIG. 6; autonomous navigation, advanced tracking and collision avoidance, etc.) at a low DAL portion of the computing architecture.

In variants, the system and/or method can be implemented in conjunction with semantic parsing of aircraft and/or ATC communications as described in: U.S. Application Serial Number 17/500,358, filed 13-OCT-2021; and/or U.S. Application Serial Number 17/719,835, filed 13-APR-2022, each of which is incorporated herein in its entirety by this reference. Additionally, the system and/or method can include and/or operate in conjunction with the pilot attention state monitoring systems and/or methods as described in U.S. Application Serial No. 18/379,095, filed 11-OCT-2023, which is incorporated herein in its entirety by this reference.

In variants, specific phonetic triggers such as vowel mergers and consonant swapping can result in dialectical homophones (e.g., with waypoints pronounced in accented English) may present a significant linguistic challenge for synthetic speech and accented speech recognition. Vowel mergers may occur with close and mid-height front vowels, namely the i and e type vowels, which often vary by dialect and are frequently merged. For example, the kit-strut merger in Glaswegian speech results in pairs like ‘fin’ and ‘fun’ being dialectic homophones; mitt–meet merger in Malaysian and Singaporean English in which the phonemes /iː/ and /ɪ/ are both pronounced /i/ which results in pairs like ‘mitt’ and ‘meet’, ‘bit’ and ‘beat’, and ‘bid’ and ‘bead’ being dialectic homophones; met–mat merger in Malaysian, Singaporean, and Hong Kong English, in which the phonemes /ɛ/ and /æ/ are both pronounced /ɛ/ which can result in pairs like met and mat, bet and bat being dialectic homophones. Consonant swapping, such as ‘r’ and ‘l’ consonant sounds being pronounced interchangeably, can likewise result in dialectic homophones (e.g., in waypoint pronunciations). Variants of the system and/or method can be used to facilitate waypoint pronunciation and/or disambiguation in conjunction with the waypoint clarification system(s) and/or method(s) as described in U.S. Application Serial Number 18/969,752, filed 12/05/2024, which is incorporated herein in its entirety by this reference, which may likewise improve handling of homophonic waypoint pronunciations in conjunction with the system(s) and method(s) described herein. For example, variants of the system and/or method can request clarification of an entity or term (e.g., waypoint) within an utterance or utterance transcript based on the accent class, such as where the accent class results in dialectic homophones (e.g., a waypoint pronunciation which may result in phonetically-conflicting waypoints based on the accent class and/or dialectic homophones within the accent class).

### 1.1 Variants

Variants of the system and/or method can facilitate responses to air traffic controllers in an accent similar to their dialect and/or native accent. Additionally, variants can generate synthetic responses which deviate from the specific voices/accents on a particular channel to avoid introducing confusion for other users (pilots) on the same radio channel (e.g., which may otherwise result from closely mimicking a speaker on the same channel).

Speaker voices and/or accents can be associated with specific call signs or identified with individual radio frequency channels, such as by segmenting ATC utterances using the system and/or method(s) as described in U.S. Application Serial No. 17/719,835, filed 13-APR-2022 and/or U.S. Application Serial No. 18/952,583, filed 19-NOV-2024, each of which is incorporated herein in its entirety by this reference. Additionally, variants can also incorporate anti-spoofing measures, such as by associating a specific vocal signature with each air traffic controller and linking voices/accents to specific call signs on the ATC radiofrequency.

Upon initial receipt of an audio utterance(s) from Air Traffic Control, the system can perform accent detection/classification as part of the initial semantic processing. For example, the ATC utterance(s) can be used to generate an embedding for the speaker which can be used to classify audio relative to a predetermined set of accent classes and output the most similar accent class (e.g., based on a similarity score). Subsequently, text-to-speech generation by the (autonomous) system can generate synthetic responses using on the identified accent class, and may additionally incorporate vocal variations to avoid direct mimicry. For example, vocal variations can include: introducing noise, adjusting the audio parameters (e.g., such as by pitch shifting the text-to-speech audio in the frequency domain), adjusting vocal cadence, pitch shifting, creak adjustment, adjusting vocal fry, switching response gender (e.g., genderless audio, alternate gender classification, etc.) and/or other vocal characteristics/parameters to avoid direct mimicry of the air traffic controller or another voice on the radio.

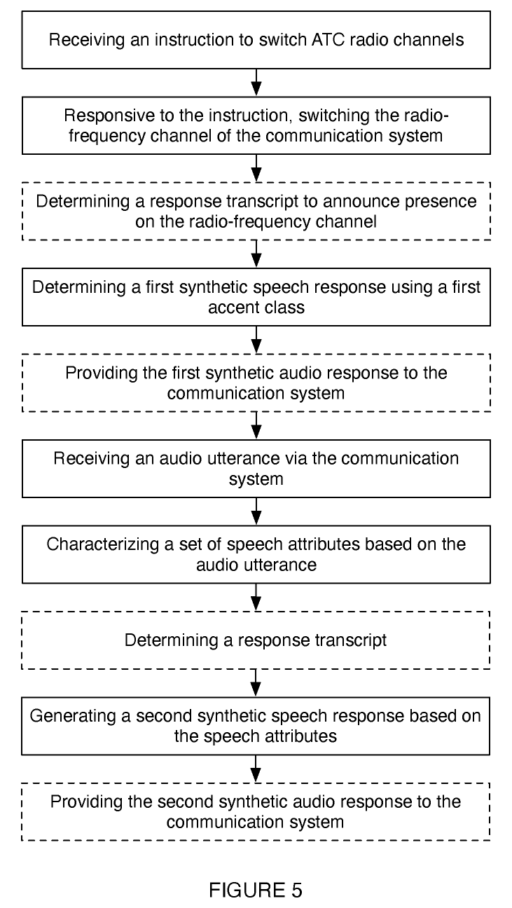

However, the pilot may commonly be required to speak on a particular channel before receiving audio from Air Traffic Control (e.g., an example is shown in FIG. 5). For example, upon switching frequencies to that of a new ATC tower (e.g., at the request of ATC), the pilot is typically the first to transmit on the new frequency (e.g., announcing themselves and callsign to the tower on the new frequency band). In such circumstances, the synthetic accent may be initialized (e.g., from the previous accent used, based on the aircraft flight plan, local geographic context, etc.) and transition towards the ATC accent responsive to the accent classification. For example, the accent may be abruptly transitioned (e.g., in conjunction with advance warning and/or a synthetic notification to the ATC; without notification to ATC) and/or gradually/smoothly transitioned (e.g., over a period of one or more synthetic utterances). Alternatively, the system may sweep the radio channel of the adjacent tower(s) along the flight plan to derive the accent prior to switching frequencies, and/or can otherwise accommodate radiofrequency changes (e.g., as may be required by ATC).

In one set of variants, the system can receive the voice input (either from the pilot or the controller) and process the speech to detect the accent. The system can extract features from the speech signal (e.g., pitch, tone, rhythm, phonetic patterns) and use a set of models (e.g., ML models, deep neural networks, support vector machines, etc.) to classify the accent. A database of various accents is maintained for classification purposes and it is kept up to date by adding new accents identified within the aviation domain. When there is no exact match the system finds the “closest” match accent is returned (e.g., the accent detection can be performed for all speakers on a radio channel).

Once the system detects the accent of the receiving party, it can generate the response with the corresponding accent using the synthetic voice generator 300. For example, if a pilot with an American accent is communicating with an ATC controller with an Indian accent the system can convert the pilot’s voice to a voice with Indian accent and vice versa. In variants, the accent modification can be performed using a deep neural network that preserves the speaker’s original identity while adjusting the phonetic and prosodic features to match the listener’s accent.

In an autonomous navigation system, a text-to-speech functionality can communicate a synthetic output to ATC, and accent modification can be applied to the text-to-speech output to match the ATC controller accent on the receiving side.

### 1.2 Illustrative Example

In variants, a method for an aircraft comprises: based on an instruction from Air Traffic Control (ATC), switching a radiofrequency channel of an ATC radio system onboard the aircraft; responsive to updating the radiofrequency channel, providing a first synthetic utterance via the ATC radio system on the first radiofrequency channel; subsequently, receiving an audio utterance from ATC on the radiofrequency channel; characterizing speech attributes of the audio utterance using an accent classification model; generating a second synthetic utterance based on the speech attributes; and responding to the audio utterance by providing the second synthetic utterance via the ATC radio system on the first radiofrequency channel.

### 2. Benefits

Variants of the technology can confer one or more advantages over conventional technologies.

First, variants can reduce ATC communication errors by facilitating synthetic communication in native accent formats.

Second, variants can improve NLP accuracy by leveraging accent-specific models, which can be more effective at detecting (and/or deconflicting) dialectic homophones, such as may result from vowel merges in various accents/dialects.

Third, variants can reduce pilot workload by leveraging NLP and (accented) synthetic voice generation systems in aircraft operations (e.g., in a fully-autonomous, semi-autonomous, and/or pilot-aid context).

However, further advantages can be provided by the system and method disclosed herein.

### 3. System

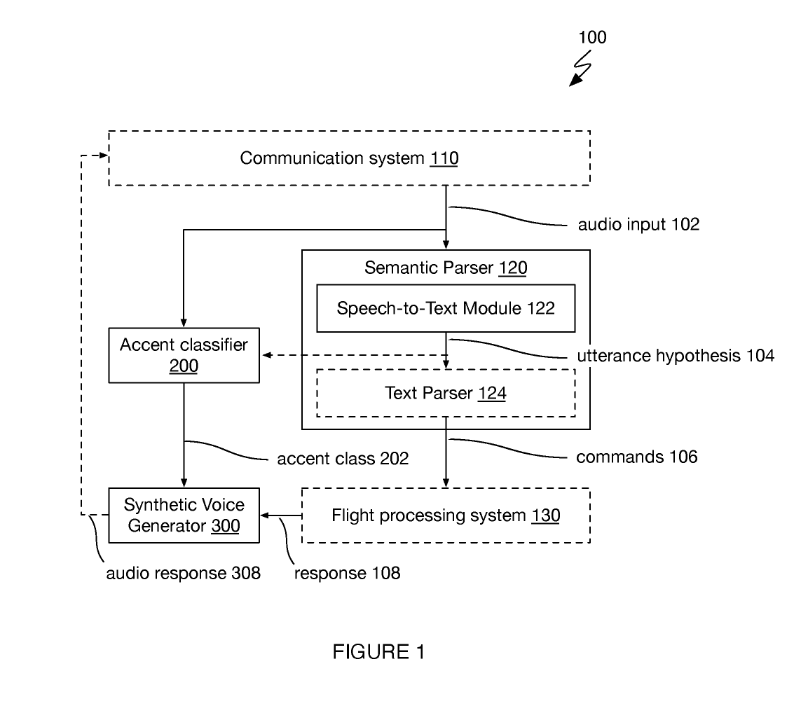

The system 100, an example of which is shown in FIG. 1, can include: a semantic parser 120, an accent classifier 200, and a synthetic voice generator 300. The system can optionally include a communication system 110 and a flight processing system 130. However, the system 100 can additionally or alternatively include any other suitable set of components. The system functions to automatically interpret flight commands from a stream of air traffic control (ATC) radio communications and respond to ATC with a selected accent and/or set of synthetic speech attributes based on the speech attributes of the speaker. Additionally, the system 100 can function to determine flight commands 106 from an audio input 102 (e.g., received ATC radio transmission) to be used for aircraft control and/or synthetic response generation.

The audio input 102 can include a unitary utterance (e.g., sentence), multiple utterances (e.g., over a predetermined window – such as 30 seconds, within a continuous audio stream, over a rolling window), periods of silence, a continuous audio stream (e.g., on a particular radio channel, such as based on a current aircraft location or dedicated ATC communication channel), and/or any other suitable audio input. In a first example, the audio input can be provided as a continuous stream. In a second example, a continuous ATC radiofrequency stream can be stored locally, and a rolling window of a particular duration (e.g., last 30 seconds, dynamic window sized based on previous utterance detections, etc.) can be analyzed from the continuous radiofrequency stream.

The audio input is preferably in the form of a digital signal (e.g., radio transmission passed through an A/D converter and/or a wireless communication chipset), however can be in any suitable data format. In a specific example, the audio input is a radio stream from an ATC station in a digital format. In variants, the system can directly receive radio communications from an ATC tower and translate the communications into commands which can be interpreted by a flight processing system. In a first ‘human in the loop’ example, a user (e.g., pilot in command, unskilled operator, remote moderator, etc.) can confirm and/or validate the commands before they are sent to and/or executed by the flight processing system. In a second ‘autonomous’ example, commands can be sent to and/or executed by the flight processing system without direct involvement of a human. However, the system 100 can otherwise suitably determine commands from an audio input.

The system 100 is preferably mounted to, installed on, integrated into, and/or configured to operate with any suitable vehicle (e.g., the system can include the vehicle). The system 100 is preferably specific to the vehicle (e.g., the modules are specifically trained for the vehicle, the module is trained on a vehicle-specific dataset), but can be generic across multiple vehicles. The vehicle is preferably an aircraft (e.g., cargo aircraft, autonomous aircraft, passenger aircraft, manually piloted aircraft, manned aircraft, unmanned aircraft, etc.), but can alternately be a watercraft, land-based vehicle, spacecraft, and/or any other suitable vehicle. In a specific example, the aircraft can include exactly one pilot/PIC, where the system can function as a backup or failsafe in the event the sole pilot/PIC becomes incapacitated (e.g., an autonomous co-pilot, enabling remote validation of aircraft control, etc.).

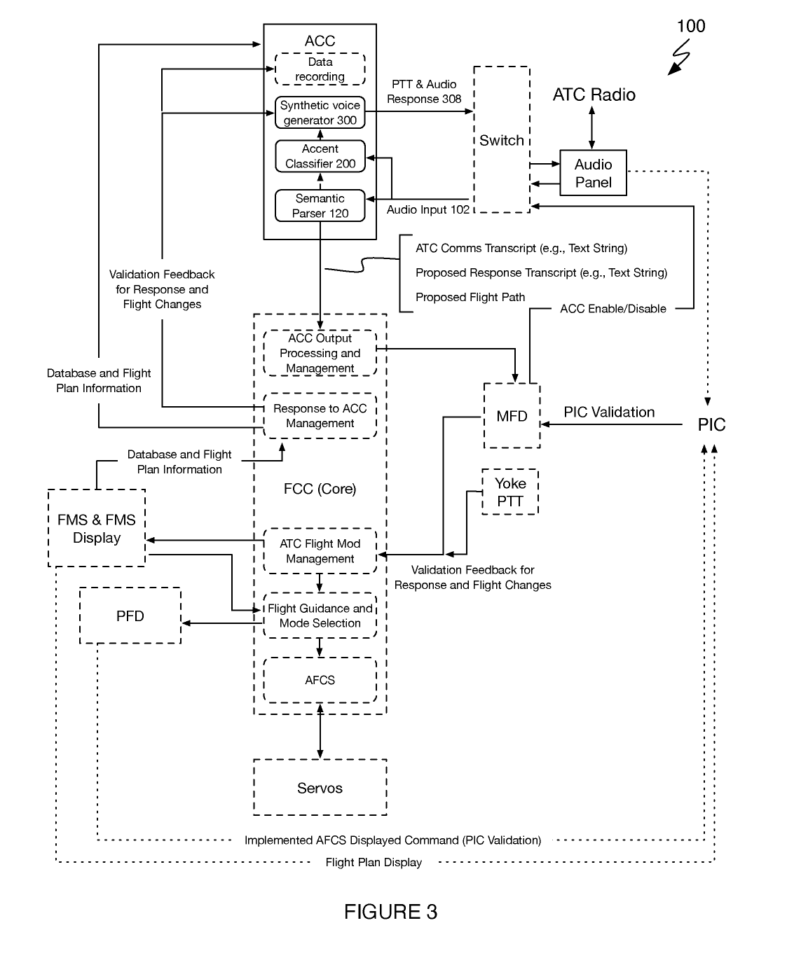

The system 100 can include any suitable data processors and/or processing modules. Data processing for the various system and/or method elements preferably occurs locally onboard the aircraft, but can additionally or alternatively be distributed among remote processing systems (e.g., for primary and/or redundant processing operations), such as at a remote validation site, at an ATC data center, on a cloud computing system, and/or at any other suitable location. Data processing for the Speech-to-Text module and/or semantic parsing can be centralized or distributed. In a specific example, the data processing for the semantic parser, accent classification, and/or synthetic voice generation can occur at a separate processing system from the flight processing system (e.g., are not performed by the FMS or FCS processing systems; ACC decoupled from the FMS/FCS processing, an example of which is shown in FIG. 3), but can additionally or alternatively be occur at the same compute node and/or within the same (certified) aircraft system. Data processing can be executed at redundant endpoints (e.g., redundant onboard/aircraft endpoints), or can be unitary for various instances of system/method. In a first variant, the system can include a first natural language processing (NLP) system at an Automated Communications Computer (ACC), which includes the semantic parser and/or Text-to-Speech system thereof, the accent classifier, and the synthetic voice generator. The ACC can be used with a second flight processing system (e.g., Core FCC), which includes the flight processing system and/or controls the communication systems (e.g., controls ATC radio functionality via a switch; enables or disables ACC). In a second variant, an aircraft can include a unified ‘onboard’ processing system for all runtime/inference processing operations. In a third variant, remote (e.g., cloud) processing can be utilized for accent classification, semantic parsing, and/or synthetic voice generation functionalities. However, the system 100 can include any other suitable data processing systems/operations.

The system 100 can optionally include or be used with a communication system 110, which functions to transform an ATC communication (e.g., radiofrequency signal) into an audio input which can be processed by the semantic parser. Additionally or alternately, the communication system can be configured to communicate a (synthetic) response to ATC. The communication system can include an antenna, radio receiver (e.g., ATC radio receiver), a radio transmitter, an A/D converter, filters, amplifiers, mixers, modulators/demodulators, detectors, a wireless (radiofrequency) communication chipset, and/or any other suitable components. The communication system can include: an ATC radio, cellular communications device, VHF/UHF radio, and/or any other suitable communication devices. In a specific example, the communication system is configured to execute S210. However, the communication system can include any other suitable components, and/or otherwise suitably establish communication with air traffic control (ATC) and/or another radio device(s). Additionally or alternatively, the communication system can couple the system with an external radio (e.g., selectively coupled via a switch), and/or the communication system can be excluded entirely (e.g., where communication systems may be entirely external to the system; such as where the system operates entirely within a portable device which can be selectively coupled to the ATC radio), and/or the system can be otherwise configured.

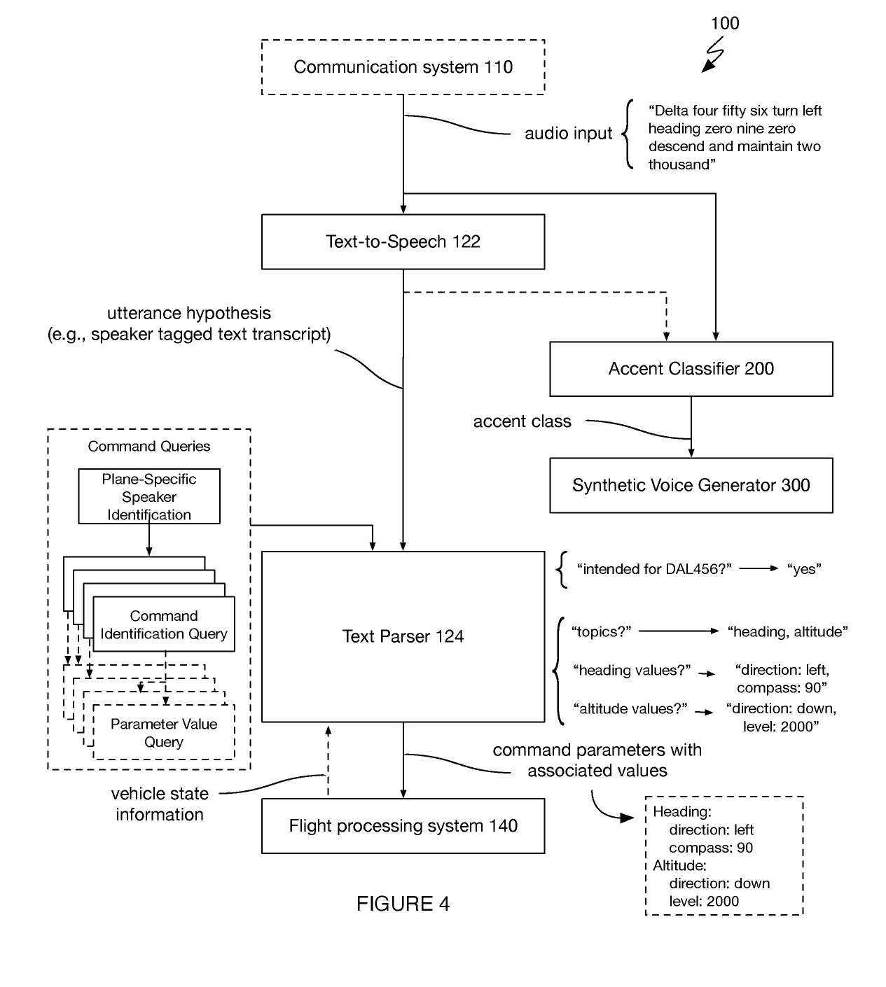

The semantic parser 120 functions to determine a set of commands 106 from the audio input 102 (e.g., an example is shown in FIG. 1, a second example is shown in FIG. 4). Additionally or alternatively, the semantic parser 120 can convert the audio input 102 (e.g., ATC radio signal) into an utterance hypothesis 104, such as in the form of a text transcript (e.g., an ATC transcript with a speaker tag) and/or sequence of phonemes, which can be used by the accent classifier 200 to facilitate accent classification (to be used for synthetic voice generation). The utterance hypothesis is preferably a text stream (e.g., dynamic transcript), but can alternatively be a text document (e.g., static transcript), a string of alphanumeric characters (e.g., ASCII characters), or have any other suitable human-readable and/or machine-readable format. Additionally or alternatively, the utterance hypothesis can be a phonetic transcript, sequence of phonemes, utterance embedding, and/or can include any other suitable information in any suitable format(s). The semantic parser can include a speech-to-text module 122 and a text parser 124. As an example, the semantic parser can include any of the system and/or method elements as described in: U.S. Application Serial No. 18/952,583, filed 19-NOV-2024, titled “SYSTEM AND/OR METHOD FOR SEMANTIC PARSING OF AIR TRAFFIC CONTROL AUDIO,” and/or U.S. Application Serial No. 18/969,752, filed 05-DEC-2024, titled “SYSTEM AND/OR METHOD FOR SEMANTIC PARSING OF AIR TRAFFIC CONTROL AUDIO,” each of which is incorporated herein in its entirety by this reference.

The speech-to-text module can include: an integrated automatic speech recognition (ASR) module, a sentence boundary detection (SBD) module, a language module, and/or other modules, and/or combinations thereof. In a specific example, the Speech-to-Text module can include an integrated ASR/SBD module. The Speech-to-Text module (and/or submodules thereof) can include a neural network (e.g., DNN, CNN, RNN, etc.), a cascade of neural networks, compositional networks, Bayesian networks, Markov chains, pre-determined rules, probability distributions, attention-based models, heuristics, probabilistic graphical models, or other models. The Speech-to-Text module (and/or submodules thereof) can be tuned versions of pretrained models (e.g., pretrained for another domain or use case, using different training data), be trained versions of previously untrained models, and/or be otherwise constructed. In an example, the speech-to-text module transforms an ATC audio stream into a natural language text transcript which is provided to the text parser 124, preserving the syntax as conveyed by the ATC speaker (e.g., arbitrary, inconsistent, non-uniform syntax).

Alternatively, the speech-to-text module can include a neural network trained (e.g., using audio data labeled with an audio transcript) to output utterance hypotheses (e.g., one or more series of linguistic components separated by utterance boundaries) based on an audio input. However, the speech-to-text module can include: only an automated speech recognition module, only a language module, and/or can be otherwise constructed.

However, the system can include any other suitable speech-to-text module.

The accent classifier functions to determine an accent class 202 for the speaker(s) on the radio channel, and more preferably an accent class 202 of ATC controller. The accent classifier preferably determines the accent class 102 from a set of inputs, which can include the (raw) audio input 102 from the communication system and/or utterances segmented by the semantic parser (e.g., those tagged in association with a speaker; etc.). Utterances (or utterance hypotheses) can optionally be encoded into an embedding for each utterance and/or speaker (e.g., at the semantic parser and/or accent classifier), such as by a set of model layers (i.e., an encoder), which can be used to facilitate classification at the accent classifier 200.

The accent classifier can include a set of models which output an accent class 202 selected from a predetermined set of accent classes (e.g., a predetermined set of synthetic accents of the synthetic voice generator 300). For example, the accent classifier can determine an accent class 202 for an air traffic controller from an embedding of at least one ATC utterance using an instance-based method (e.g., nearest neighbor clustering algorithm).

The accent class 202 determined by the accent classifier is preferably provided to the synthetic voice generator 300, which can be used to generate (synthetic) audio responses 308 based on the accent class. Additionally or alternatively, the accent classifier and/or models thereof can characterize (e.g., score, classify, extract, etc.) speech attributes from the utterance, which can include audio parameters (e.g., pitch), vocal cadence, vocal creak, vocal fry, vocal gender, accent class, and/or other vocal characteristics/parameters. The speech attributes can be provided to the synthetic voice generator 300, such as to facilitate synthetic speech in a substantially similar accent (e.g., without directly mimicking speech attributes of the speaker).

Accent classes can be geographic (e.g., local or within a few miles of a specific town in the UK), regional (e.g., Southern US), national (e.g., Australian), ethnic, cultural, and/or otherwise defined. For example, English has over 160 recognized accents worldwide, with significant regional and cultural diversity even within the UK (e.g., Cockney, Estuary English, Geordie, Scouse, Brummie, Yorkshire/Northern, West County, Multi-cultural London English, etc.; towns within 10 miles of Manchester, such as Bolton, Oldham, Rochdale, and Salford have distinct accents, all sub-classes of the Lancashire accent) and US. Conversely, Australian English is relatively homogeneous, with some accent variation between states (e.g., typically evaluated on a continuum between Broad Australian, General Australian, and Cultivated Australian). Variants may classify (and/or train dedicated models with) any suitable classes or sub-classes of language/accents.

The models of the semantic parser, speech-to-text module, text parser, and/or accent classifier can include classical or traditional approaches, machine learning approaches, and/or be otherwise configured. The models can include regression (e.g., linear regression, non-linear regression, logistic regression, etc.), decision tree, LSA, clustering, association rules, dimensionality reduction (e.g., PCA, t-SNE, LDA, etc.), neural networks (e.g., CNN, DNN, CAN, LSTM, RNN, encoders, decoders, deep learning models, transformers, etc.), ensemble methods (e.g., accent-aware ensembles of multiple sub-models, each trained on different accent or regional dialect), optimization methods, classification, rules, heuristics, equations (e.g., weighted equations, etc.), selection (e.g., from a library), regularization methods (e.g., ridge regression), Bayesian methods (e.g., Naiive Bayes, Markov), instance-based methods (e.g., nearest neighbor), kernel methods, support vectors (e.g., SVM, SVC, etc.), statistical methods (e.g., probability), comparison methods (e.g., matching, distance metrics, thresholds, etc.), deterministics, genetic programs, and/or any other suitable model. The models can include (e.g., be constructed using) a set of input layers, output layers, and hidden layers (e.g., connected in series, such as in a feed forward network; connected with a feedback loop between the output and the input, such as in a recurrent neural network; etc.; wherein the layer weights and/or connections can be learned through training); a set of connected convolution layers (e.g., in a CNN); a set of self-attention layers; and/or have any other suitable architecture.

Models can be trained, learned, fit, predetermined, and/or can be otherwise determined. The models can be trained or learned using: supervised learning, unsupervised learning, self-supervised learning, semi-supervised learning (e.g., positive-unlabeled learning), reinforcement learning, transfer learning, Bayesian optimization, fitting, interpolation and/or approximation (e.g., using gaussian processes), backpropagation, and/or otherwise generated. The models can be learned or trained on: labeled data (e.g., data labeled with the target label), unlabeled data, positive training sets (e.g., a set of data with true positive labels, negative training sets (e.g., a set of data with true negative labels), and/or any other suitable set of data.

Any model can optionally be validated, verified, reinforced, calibrated, or otherwise updated based on newly received, up-to-date measurements; past measurements recorded during the operating session; historic measurements recorded during past operating sessions; or be updated based on any other suitable data.

Any model can optionally be run or updated: once; at a predetermined frequency; every time the method is performed; every time an unanticipated measurement value is received; or at any other suitable frequency. Any model can optionally be run or updated: in response to determination of an actual result differing from an expected result; or at any other suitable frequency. Any model can optionally be run or updated concurrently with one or more other models, serially, at varying frequencies, or at any other suitable time.

However, the system can include any other suitable components.

### 4. Method

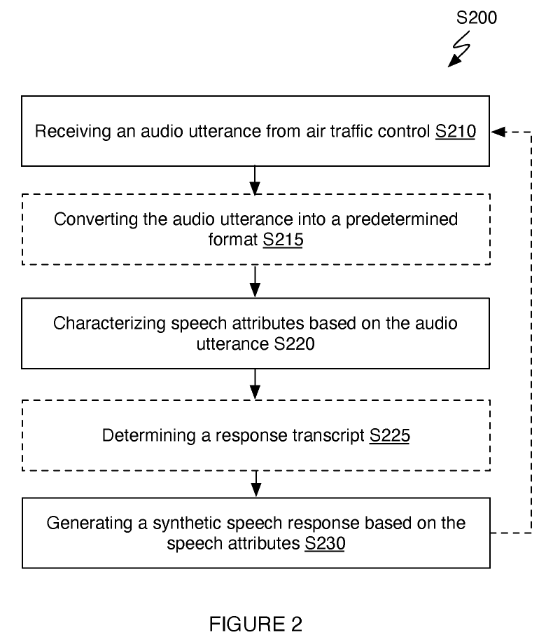

The method S200, an example of which is shown in FIG. 2, can include: receiving an audio utterance from air traffic control S210, characterizing speech attributes based on the audio utterance S220, and generating a synthetic speech response based on the speech attributes S230. The method can optionally include: converting the audio utterance into a predetermined format S215, determining a response S225, and/or any other suitable element(s). However, the method can include any other suitable elements. The method functions to automatically interpret flight commands from a stream of air traffic control (ATC) radio communications and respond to ATC with a selected accent and/or set of synthetic speech attributes based on the speaker attributes.

All or portions of S200 can be performed continuously, periodically, sporadically, in response to transmission of a radio receipt, during aircraft flight, in preparation for and/or following flight, at all times, and/or with any other timing. S200 can be performed in real- or near-real time, or asynchronously with aircraft flight or audio utterance receipt. S200 is preferably performed onboard the aircraft, but can alternatively be partially or entirely performed remotely.

Receiving an audio utterance from air traffic control S210 functions to receive a communication signal at the aircraft and/or convert the communication signal into an audio input, which can be processed by the semantic parser and/or accent classifier. In a specific example, S210 transforms an analog radio signal into a digital signal using an A/D converter (and/or other suitable wireless communication chipset), and sends the digital signal to the ASR module (e.g., via a wired connection) as the audio input. S210 preferably monitors a single radio channel (e.g., associated with the particular aircraft), but can alternately sweep multiple channels (e.g., to gather larger amounts of ATC audio data; sweeping the next radio channel(s) of the next ATC tower based on the flight plan; etc.). However, S210 can otherwise suitably receive an utterance.

Optionally converting the audio utterance into a predetermined format S215 functions to generate a transcript from the ATC audio. This can be performed by the Speech-to-Text module or other system component. Converting the audio utterance to into a predetermined (e.g., text) format can include: determining a set of utterance hypotheses for an utterance; selecting an utterance hypothesis from the set of utterance hypotheses; segmenting an utterance from the audio input; determining a speaker tag for an utterance; determining an embedding for an utterance; and/or any other suitable elements. However, the ATC audio can be otherwise converted into any other suitable format(s).

Characterizing speech attributes based on the audio utterance 220 functions to characterize the accent and/or speech attributes of a speaker (e.g., air traffic controller; a pilot on the radio channel; etc.) based on the audio utterance. The speech attributes can be characterized individually (e.g., separate parameter values for individual attributes) and/or collectively (e.g., binned; categorized into a predetermined set of speech/accent/dialect classes). More preferably, the speech attributes can include an accent class determined for the speaker. Additionally or alternatively, the speech attributes can include audio parameters (e.g., pitch), vocal cadence, vocal creak, vocal fry, vocal gender, accent class, and/or other vocal characteristics/parameters. The speech attributes can be provided to the synthetic voice generator 300, such as to facilitate synthetic speech in a substantially similar accent (e.g., without directly mimicking speech attributes of the speaker).However, any other suitable speech attributes can be determined based on the audio utterance.

The speech attributes are preferably determined using the accent classifier 200 and/or a set of models thereof. For example, the accent class can be selected from a predetermined set of accents using nearest neighbor clustering for an accent embedding of the utterance. As a second example, the accent class can be determined using a multi-headed classifier (e.g., with each head trained to score a particular accent). However, the speech attributes and/or accent class can be otherwise determined.

Optionally determining a response transcript S225 functions to provide the input for S230 for synthetic text-to-speech generation. The response transcript and/or constituent elements thereof can be: predetermined (e.g., for announcing presence on a new radiofrequency channel; aircraft callsign received prior to departure and/or based on flight plan); dynamically determined (e.g., based on aircraft configuration and/or aircraft state, such as current altitude, heading, airspeed, location, etc.; determined based on flight plan information from the FMS); automatically determined (e.g., in response to semantic parsing of an ATC command); manually determined (e.g., provided by a pilot-in-command, such as by manual text input and/or automatic speech-to-text); manually verified (e.g., PIC validation at the MFD); and/or otherwise determined. As an example, the response transcript can be determined by translating pilot speech into a text transcript (e.g., which can facilitate accent translation for a pilot response into the synthetic, accented speech of the synthetic voice generator to broadcast to ATC).

However, the response transcript can be otherwise determined.

Generating a synthetic speech response based on the speech attributes S230 transforms the response transcript into a (synthetic) audio response 308 to be provided to the communication system 110 (e.g., to be transmitted via the ATC radio). Preferably, the synthetic voice generator determines the audio response using a pretrained model for the accent class 202 determined by the accent classifier. Additionally or alternatively, the audio response can be post-processed based on the speech attributes, to increase dissimilarity to the speech attributes of the ATC controller.

For instance, in variants S230 can optionally score the similarity of the (default) synthetic voice for the accent class to the speech attributes and, responsive to the score satisfying a similarity threshold, adjust the (synthetic) audio response to reduce the similarity. For example, pitch shifting the synthetic audio (e.g., by half an octave, full octave, etc.) may preserve the ‘familiarity’ of the accent while avoiding confusion between voices of similar pitch. Post-post processing adjustments (e.g., based on similarity of the speech attributes) can include: pitch shifting, frequency domain transforms, vocal cadence adjustment, creak adjustment, adjusting vocal fry, switching response gender (e.g., genderless audio, alternate gender classification, etc.) and/or any other suitable other audio post-processing transformation(s).

However, S230 can include any other suitable elements, and/or can be otherwise configured.

The method S200 can optionally include determining commands from the utterance hypothesis using the semantic parser S240, which functions to extract flight commands from the utterance hypothesis, which can be interpreted and/or implemented by a flight processing system. Commands can be used for responses determination in S225 and/or to facilitate control of the aircraft, such as in conjunction with the system(s) and/or method(s) as described in 18/952,583, filed 19-NOV-2024, which is incorporated herein in its entirety by this reference.

The method S200 can optionally include controlling the aircraft based on the commands, which functions to modify the aircraft state according to the utterance (e.g., ATC directives). In a specific example, autonomously controls the effectors and/or propulsion systems of the aircraft according to the commands (e.g., to achieve the commanded values). In a second example, the flight processing system can change waypoints and/or autopilot inputs based on the commands. In variants, S200 can include providing the commands to a flight processing system (e.g., FCS) in a standardized format (e.g., a standardized machine-readable format). However, the method S200 can otherwise suitably control the aircraft based on the commands. Alternatively, the system can be used entirely in an assistive capacity (e.g., without passing commands to an aircraft processor or controlling the aircraft, such as to enable control of an aircraft by a hearing-impaired pilot), and/or can be otherwise used.

However, the method S200 can additionally or alternatively include any other suitable elements.

### 5. Communication Validation

In one set of variants, the system and/or method can optionally include and/or can be utilized with a Multi-Function Display (MFD) which functions to display messages to the pilot (e.g., with a speech to text functionality and/or semantic parsing of key parameters/information; ATC messages; checklist challenges; audio response transcripts; accent classes; etc.), provide the system inputs response and action validation, and/or provide pilot inputs (e.g., a variant of the system integrating a MFD is illustrated in FIG. 3). The system can display information to the pilot (e.g., advisory messages, checklist tasks, etc.), which can include: the original advisory/message, the proposed response (e.g., when applicable; in a dedicated or persistently allocated space/region of the display; as a pop-up menu or notification; etc.), the proposed response accent class, the proposed action to take (e.g., when applicable; in a dedicated or persistently allocated space/region of the display; as a pop-up menu or notification; etc.), and/or any other suitable information.

The screen can also display options for rejecting and accepting the proposed response, response accent, and/or command. The options can be activated by soft buttons, a touch screen located on the MFD (e.g., via a touch screen input such as a touch, press-and-hold, swipe, etc.), and/or via any other input components. In variants, options can additionally be confirmed/validated by a secondary input (e.g., soft button confirmation) after a selected action and/or buttons may be physically distanced/separated (e.g., which may reduce/avoid pilot errors or inadvertent actions). In variants, reading in Push-To-Talk [PTT] audio, such as by Automatic Speech Recognition (ASR), can be used to confirm, cancel, and/or facilitate any other suitable set of pilot inputs (e.g., from a set of predefined checklist responses, etc.).

In variants, in addition to the accept/reject options on the MFD, the Pilot can have an additional method to provide binary responses via a two-position switch located on the yoke. The first position can confirm or accept a proposed response. The second position can both reject a proposed response (when available) and provide/activate the Pilot’s PTT function. As an example, the two-position switch can replace an existing single position PTT switch (e.g., which may be natively integrated on a certified aircraft). Due to the frequency of ATC messages and/or checklist responses, the yoke switch may provide a more ergonomic option compared to the MFD buttons. This option can also reduce changes to the procedure for responding to ATC and/or checklist procedures.

In variants, the automated communication functions can be enabled by a switch activated through the MFD. The Automated Communication Computer (ACC) can host natural language processing (NLP) and synthetic voice generation functions and can be connected to the audio panel through an enable switch. As an example, the switch can send a discrete signal to/via the FCC so the FCC receives the ACC state (e.g., and then the FCC can send a discrete signal to the switch). If the system malfunctions, the PIC may have the option to disconnect the ACC from the radios and/or checklist engine. Accordingly, any system failures can be localized and/or may not interfere with the pilot’s communication.

Upon powerup, the ACC can receive the aircraft tail number (and/or additional aircraft identification parameter[s]) from the FCC.

The automated communication function may utilize flight plan information to assist interpretation of messages, such as determining nearby waypoints and/or default synthetic accent class(es) for a geographic region. At the start of a flight, the FMS can send the flight plan and surrounding (and/or regional) navigational database information to the ACC. This information can include one or more of: flight plan, surrounding waypoints along the route, arrival and departure airports, SIDS, STARS, runways, and/or any other suitable information. If there is a change to the flight plan during the flight, the updated information can be sent to the ACC. Synthetic voice generation, NLP of pilot audio (PTT), and/or flight advisory actions/resolutions may likewise be utilized in conjunction with various aircraft procedures and/or can be otherwise suitably implemented.

Different subsystems and/or modules discussed above can be operated and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method for an aircraft comprising:
based on an instruction from Air Traffic Control (ATC), switching a radiofrequency channel of an ATC radio system onboard the aircraft;
responsive to updating the radiofrequency channel, providing a first synthetic utterance via the ATC radio system on the first radiofrequency channel;
subsequently, receiving an audio utterance from ATC on the radiofrequency channel;
characterizing speech attributes of the audio utterance using an accent classification model;
generating a second synthetic utterance based on the speech attributes; and
responding to the audio utterance by broadcasting the second synthetic utterance via the ATC radio system on the first radiofrequency channel.

2. The method of claim 1, wherein the speech attributes comprise an accent classification of the audio utterance.

3. The method of claim 2, the method further comprising:
determining a text transcript of the audio utterance using Natural Language Processing (NLP); and
based on the accent classification, determining a phonetically-conflicting waypoint entity within the text transcript based on a dialectic homophone associated with the accent classification, wherein the second synthetic utterance is determined based on the dialectic homophone.

4. The method of claim 1, wherein the first synthetic utterance is generated using a first accent class, wherein the second synthetic utterance is generated using a second accent class based on the speech attributes, wherein the second accent class is different from the first accent class.

5. The method of claim 4, wherein the first accent class is determined based on a geographic context.

6. The method of claim 4, wherein the speech attributes comprise a vocal gender classification and an accent classification, wherein the second synthetic utterance is synthetically generated using the second accent class based on the accent classification and with a different vocal gender than the vocal gender classification.

7. The method of claim 4, wherein generating the second synthetic utterance comprises pitch shifting the second synthetic utterance based on the speech attributes.

8. The method of claim 1, wherein the speech attributes comprise a first subset of attributes and a second subset of attributes, wherein the second synthetic utterance is generated to mimic the first set of attributes and deviate from the second set of attributes.

9. The method of claim 1, wherein the accent classification model comprises an ensemble of accent classifiers, each pre-trained to determine a similarity score for a respective accent.

10. The method of claim 9, wherein the second synthetic utterance is generated with the respective accent associated with the highest similarity score of the ensemble.

11. The method of claim 1, wherein characterizing the speech attributes of the audio utterance comprises: determining an accent embedding for the audio utterance using the accent classification model; and, using the accent embedding, determining an accent class from a predetermined set of accents using nearest neighbor clustering.

12. The method of claim 11, wherein the second synthetic utterance is generated using a synthetic voice specific to the accent class.

13. The method of claim 1, wherein generating the second synthetic utterance comprises post-processing the synthetic audio to reduce similarity with the audio utterance.

14. The method of claim 13, wherein post-processing the synthetic audio comprises pitch shifting.

15. The method of claim 1, wherein the first synthetic utterance is determined based on the aircraft callsign and aircraft state.

16. The method of claim 1, wherein the second synthetic utterance is automatically broadcast in response to pilot verification of a response transcript.

17. A method for an aircraft comprising:
receiving an audio signal from Air Traffic Control (ATC) via an radio system onboard the aircraft;
determining a text-based utterance hypothesis from the ATC audio signal;
parsing the utterance hypothesis using a pre-trained language model to determine a set of commands;
characterizing speech attributes of the audio utterance using an accent classification model, the speech attributes comprising an accent class;
based on the set of commands, generating a synthetic response using the accent class; and
broadcasting the synthetic response via the radio system.

18. The method of claim 17, wherein the synthetic response is generated using a Text-To-Speech (TTS) model specific to the accent class.

19. The method of claim 17, wherein parsing the utterance hypothesis comprises: based on the text-based utterance hypothesis, querying the pre-trained language model with a plurality of queries, each query comprising natural language.

20. A system onboard an aircraft, the system comprising:
a communication system comprising an Air Traffic Control (ATC) radio; and
a computing system coupled to the communication system and configured to receive an ATC audio signal from the communication system, the computing system comprising:
a semantic parser configured to determine a set of instructions from the ATC audio signal using a language model;
an accent classifier configured to determine an accent class based on the ATC audio signal using a machine learning (ML) model; and
a synthetic voice generator configured to determine a synthetic audio response to the ATC audio signal, using the accent class, based on the aircraft commands.
